(19) United States
(12) Patent Application Publication
(10) Pub. No.: US 2005/0248749 A1
(43) Pub. Date: Nov. 10, 2005

(54) Method and an apparatus for distance measurement

(75) Inventors: Michael Kiehn, Hamburg (DE); Kirsten Gosch, Hamburg (DE); Michael Köhler, Hamburg (DE); Volker Willhoeft, Hamburg (DE)

Correspondence Address: HARNESS, DICKEY & PIERCE, P.L.C., P.O. BOX 828, BLOOMFIELD HILLS, MI, 48303, US

(73) Assignee: IBEO Automobile Sensor GmbH, Hamburg (DE)

(21) Appl. No.: 11/124,738

(22) Filed: May 9, 2005

(30) Foreign Application Priority Data
May 10, 2004 (DE) 10 2004 022 912.0
Dec. 23, 2004 (EP) 04 030 615.1

(51) Int. Cl. G01P 3/36; G01S 13/08; G01S 1/30

(52) U.S. Cl. 356/28; 342/118; 342/135; 356/28.5

(57) ABSTRACT

The invention relates to a method for distance measurement by determining the pulse transit time, in which pulsed electromagnetic radiation is transmitted using at least one transmitter and signal pulses reflected at objects are detected using at least one receiver, wherein at least one received logic signal containing logic signals is generated from the received analog signal containing the signal pulses, in particular by means of a threshold circuit, and is evaluated with respect to the transit times of the logic signals, and wherein the received logic signal is read into a programmable logic circuit by means of a clocked data reading device and is mapped onto a time pattern in the logic circuit, in that instantaneous values of the received logic signal are stored in logic units of the logic circuit associated with the time windows for time windows of the time pattern corresponding to at least one clock pulse of the data reading device. The invention moreover relates to an apparatus for distance measurement.

### CROSS-REFERENCE TO RELATED APPLICATIONS

This application claims the benefit of German Application No. 10 2004 022 912.0, filed May 10, 2004, and European Application No. EP 04 030 615.1, filed Dec. 23, 2004. The disclosures of the above applications are incorporated herein by reference.

### FIELD OF THE INVENTION

The invention relates to a method for distance monitoring using transmitted and received radiation.

### BACKGROUND OF THE INVENTION

The invention relates to a method for distance measurement by determination of the pulse transit time, in which pulsed electromagnetic radiation is transmitted using at least one transmitter and signal pulses reflected at objects are detected using at least one receiver, wherein at least one received logic signal containing logic signals is generated from the received analog signal containing the signal pulses, in particular by means of a threshold circuit, and is evaluated with respect to the transit times of the logic signals.

The invention moreover relates to an apparatus for distance measurement by determining the pulse transit time, comprising at least one transmitter for the transmission of pulsed electromagnetic radiation and at least one receiver for the detection of signal pulses reflected at objects, wherein a conversion device, in particular a threshold circuit, is positioned downstream of the receiver and at least one received logic signal containing logic signals can be generated from the received analog signal containing the signal pulses using said conversion device.

Methods and apparatus of this kind are generally known, in particular from the field of laser measurement instruments which work according to the pulse transit time measurement method also called the “time of flight principle”. With such laser measurement instruments, the intensity of the detected reflected radiation is continuously converted into an electrical voltage by the receiver. The time curve of this received voltage represents a received analog signal also termed a backscatter curve.

When the backscatter curve lies above the respective threshold value and when it lies below it is determined using a threshold circuit which in particular includes one or more comparators. In the former case, the result can be evaluated as a logic “1” and in the latter case as a logic “0”. If the received analog signal is temporarily above the threshold due to a signal pulse which corresponds to an object at which a transmitted radiation pulse was reflected, the threshold circuit therefore generates a logic pulse. A plurality of analog signal pulses of this kind consequently result in a corresponding plurality of logic pulses. A start pulse defining the starting time of the measurement usually serves in practice as the reference point in time for the transit time measurement based, for example, on the rising flanks of the logic signal pulses. In this process, the rising flank of the logic signal pulse, that is the point in time at which the received analog signal has broken through the threshold, is e.g. termed an “event”. The distance from the object from which the (analog) signal pulse originates can then be calculated via the speed of light from the time difference between the rising flanks of the (logic) starting pulses and of the (logic) signal pulse. Typically, the falling flanks of the logic signal pulses are also measured as events to obtain information on the pulse widths. The time measurement is consequently of decisive importance.

Higher and higher demands are being made in practice both on the measuring sensitivity, the measuring precision and on the measuring speed. At the same time, the measurement systems should be manufacturable at favorable cost in order e.g. to keep the total costs within justifiable limits as additional components in mass-produced units serving for the most varied applications.

Particularly with laser measurement systems, an enormous amount of time and money is used to try to achieve a measuring precision or measuring resolution which is as high as possible, since very short time intervals have to be measured due to the speed of light. A distance difference of, for example, 1 cm corresponds to a transit time difference of approximately 66 ps. To be able to satisfy demands of this kind on the time measurement, special ASIC modules have previously been used which makes the resulting measurement systems comparatively expensive due to the high development costs.

### SUMMARY OF THE INVENTION

It is an object of the invention to provide a possibility in the distance measurement—by a determination of the pulse transit time—to realize a measuring precision which is as high as possible with a cost effort which is as low as possible, with the possibility in particular also having to be provided of being able to measure a plurality of events with one measurement.

This object is satisfied in accordance with the invention, on the one hand, by the features of the independent method claim and in particular in that, in the method, the received logic signal is read into a programmable logic circuit by means of a clocked data reading device and is mapped on a time pattern in the logic circuit in that instantaneous values of the received logic signal are stored in logic units of the logic circuit associated with the time windows for time windows of the time pattern corresponding to at least one clock pulse of the data reading device.

The solution of the underlying object of the invention takes place, on the other hand, by the features of the independent apparatus claim and in particular in that a measurement device having a clocked data reading device and a programmable logic circuit is positioned downstream of the conversion device, with the received logic signal read in by means of the data reading device being able to be mapped onto a plurality of logic units of the logic circuit and with instantaneous values of the received logic signal being able to be stored in logic units of the logic circuit associated with the time windows of the time pattern for time windows corresponding to at least one clock pulse of the data reading device.

In accordance with the invention, a freely programmable logic circuit is used to map the received logic signal supplied e.g. from a threshold circuit in a time-patterned manner in the logic units of the logic circuit also termed logic cells. Freely programmable logic circuits are in particular available at comparatively low cost as standard modules in the form of FPGAs (field programmable gate arrays).

It has been found in accordance with the invention that the flexibility and the high speed of modules of this kind can be utilized in an advantageous manner for a time measurement with high resolution when it is possible to supply the received logic signals, in particular generated by means of a threshold circuit, to the programmable logic circuit in an unambiguously and precisely defined manner. This is achieved in accordance with the invention by means of a clocked data reading device such as is available in modern FPGAs in the form of interfaces designed for high data sensing speeds. These FPGA interfaces can be used in accordance with the invention as pure fast serial to parallel converters, while bypassing all other interface components such as protocol functions, to put the received logic signals in a time pattern, i.e. to sample them.

It was found against all expectations that FPGAs provided with so-called MGTs (multi-gigabit transceivers) are in particular exceptionally suitable for sampling functions on received logic signals in time measurements making high demands on the precision. Modern FPGAs make clocking rates or sampling rates of, for example, 3.125 GHz available. A resolution in the distance measurement of approximately 5 cm can be achieved on the basis of a clock rate of this kind. Since FPGAs with a sampling rate of up to 10 GHz are already in preparation, the measuring precision achievable with the invention can therefore still be substantially increased in the future.

The logic units associated with the time windows of the time pattern reflect the logic state of the received logic signal in the respective time intervals due to the mapping in accordance with the invention of the received logic signal on the time pattern of the logic circuit. The information is thus respectively stored in the logic units whether the received analog signal was above or below the respective threshold at the respective point in time. The distance can thus be calculated, while taking the speed of light into account, at which the transmitted radiation pulse was reflected such that the intensity of the reflected signal pulse is above the threshold. The precision of this distance measurement depends on the fineness of the time pattern.

A simple possibility to increase the fineness or the resolution of the time pattern and thus the precision of the time measurement and thus of the distance measurement is the use of high clock rates. As mentioned above, FPGAs with MGTs can, for example, be used for this purpose which already provide a very high base clock for the sampling of the received logic signal.

It has moreover been found in accordance with the invention that programmable logic circuits such as FPGAs particularly provide the advantageous possibility of also achieving very high resolutions with a relatively low base clock by specific technical circuit and programming measures—which will be looked at in more detail in the following—such that a use of MGTs can be omitted, whereby a further substantial cost reduction can be achieved.

The measures mentioned in particular consist of carrying out phase shifts either of a given base clock, whereby a sampling with a plurality of time-displaced clocks is realized, or of the received logic signal, with a combination of both measures also being possible. Both measures ultimately result in an effective increase of the sampling rate and can also be carried out in conjunction with MGTs, whereby enormously high resolutions can be achieved.

On a phase shift of the base clock, the same received logic signal is sampled several times in time displacement. The number of the logic units mapping the received signal corresponds to the number of time intervals or time windows of the higher effective clock; the time windows become shorter, i.e. the time pattern becomes finer.

The clock, and thus the number of the time windows, admittedly does not change due to a phase shift of the received logic signal. Nevertheless, ultimately, the same received logic signal is likewise sampled a plurality of times so that a plurality of instantaneous values of the received logic signal—namely at different points in time—are determined for each time window and are stored in the logic units. A plurality of logic units are therefore used for every time window, i.e. the time pattern likewise becomes finer.

The above-mentioned measures can take place both internally and externally with respect to the programmable logic circuit. Generally, all technically possible circuit and/or programming measures for the generation of phase shifts of the base clock and/or of the received logic signal can be considered.

A particular advantage of the invention consists of the fact that, in principle, any number of events, ultimately only limited by the resolution of the time pattern, can be measured in one single measurement, i.e. for one single transmitted radiation pulse. If a reflection of the transmitted radiation pulse takes place at a plurality of objects—whereby the received analog signal contains a corresponding number of signal pulses and, consequently, the received logic signal contains a corresponding number of logic pulses—the time pattern formed by the logic units of the logic circuit automatically contains the information on the distances of all objects. In accordance with the invention, a plurality of events can thus be measured for a single transmitted radiation pulse and so practically simultaneously.

The measurement method or measurement system hereby has so-to-say a “built-in” noise tolerance, since a noise pulse admittedly surpassing a threshold, but not corresponding to an object of interest would indeed be detected, but would not block the measurement device for all signal pulses arriving later. It is rather the case that occasional noise pulses would initially be measured like “normal” events. An evaluation unit downstream of the logic circuit can be designed such that noise pulses can be recognized as such in the later evaluation and can then be eliminated.

In an application of the invention, e.g. in laser scanners which are used, for example, in motor vehicles, a noise pulse would already be eliminated by algorithms for the recognition and tracking of objects during the evaluation e.g. in that no further reflections can be detected in the neighborhood of an “object” initially simulated by the noise pulse which are expected for objects actually present in the environment of the vehicle fitted with the laser scanner.

Furthermore, the noise tolerance in accordance with the invention advantageously permits the threshold of a threshold circuit to be placed closer to the noise than is possible with measurement systems which are already “blind” for following signals in the same measurement, i.e. with respect to the same transmitted radiation pulse, after one signal or a low number of signals exceeding the threshold.

In that, in accordance with the invention, the threshold can be lowered with respect to known measurement systems without impairing the evaluation of the distance data, a considerable increase in sensitivity can be achieved with the method or system in accordance with the invention.

Preferred embodiments of the invention are also recited in the dependent 1 claims, in the description and in the drawing.

The instantaneous values of the received logic signal are preferably stored in the logic units of the logic circuit until the received logic signal has been completely read in. The received logic signal in a time pattern can then be further processed as a whole and in particular be supplied to a downstream evaluation unit as the result of the measurement.

In a particularly preferred embodiment of the invention, a plurality of received logic signals are generated from the received analog signal in that the received analog signal is directed simultaneously or sequentially over a plurality of thresholds of a threshold circuit.

A time curve of the threshold effectively going into the evaluation of the measurement ideally adapted to the respective application can be fixed by the application of a plurality of thresholds to the received analog signal.

The received analog signal is preferably directed simultaneously over the plurality of thresholds so that a plurality of different received logic signals are generated from one received analog signal and are supplied to the programmable logic circuit in parallel. Each of these received logic signals can then be mapped as a measurement result onto a time pattern of the logic circuit, whereby practically a plurality of different measurement results are present for one measurement and differ with respect to the threshold applied to the received analog signal, which can represent an interesting data basis for the evaluation for specific applications.

In accordance with the invention, it is, however, alternatively also possible to derive a single measurement result from a plurality of the received logic signals supplied to the logic circuit. It is in particular possible to switch between the individual received logic signals arriving in parallel during the measurement so that the received logic signal present as a result in a time patterned form is actually composed of a plurality of sections of different received logic signals which differ from one another with respect to a threshold generating them.

Different thresholds can be taken into account in the subsequent evaluation of the measurement result since the points in time of the switching between the individual received logic signals, i.e. the points in time of the threshold changes, are known and the respective threshold value can therefore be associated with each logical state in the logic units on the basis of this time information.

In a further preferred aspect of the invention, the thresholds or one of the thresholds used simultaneously can be provided in the form of a so-called adaptive threshold whose level varies over time in dependence on the received analog signal. The time curve of the threshold is thus not pre-determined, but the respective received analog signal itself determines the threshold curve.

A preferred possibility for the generation of an adaptive threshold of this kind consists in accordance with the invention of filtering the received analog signal. The adaptive threshold is in particular generated by low-pass filtering of the received analog signal.

In accordance with the invention, a threshold circuit having at least one comparator is preferably provided for the generation of the received logic or digital signal, with the received analog signal being supplied to said threshold circuit. Alternatively, an analog-digital converter can be provided as the conversion device with which a received digital or logic signal is likewise generated from the received analog signal. The analog-digital converter can be provided separately or as a component of the measurement device. The analog-digital converter can in particular be positioned upstream of the programmable logic circuit, in particular of an FPGA, or can be integrated in the logic circuit or in the FPGA. In the latter case, an analog interface is practically provided.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1a shows schematically, the basic design of a measurement device in accordance with the invention;

FIG. 1b shows the basic design for a sampling method in accordance with the invention;

FIG. 2 shows a schematic representation for the explanation of the use in accordance with the invention of a plurality of thresholds;

FIG. 3 shows schematically, the principle in accordance with the invention of an adaptive threshold;

FIG. 4 shows a representation for the explanation of a synchronization principle in accordance with the invention;

FIGS. 5a and 5b show representations for the explanation of a principle in accordance with the invention for the reduction of the data processing speed; and

FIG. 6 shows a block diagram for the explanation of the reduction principle for the example of a 2-bit counter.

### DETAILED DESCRIPTION OF THE PREFERRED EMBODIMENTS

The following description of the preferred embodiment(s) is merely exemplary in nature and is in no way intended to limit the invention, its application, or uses.

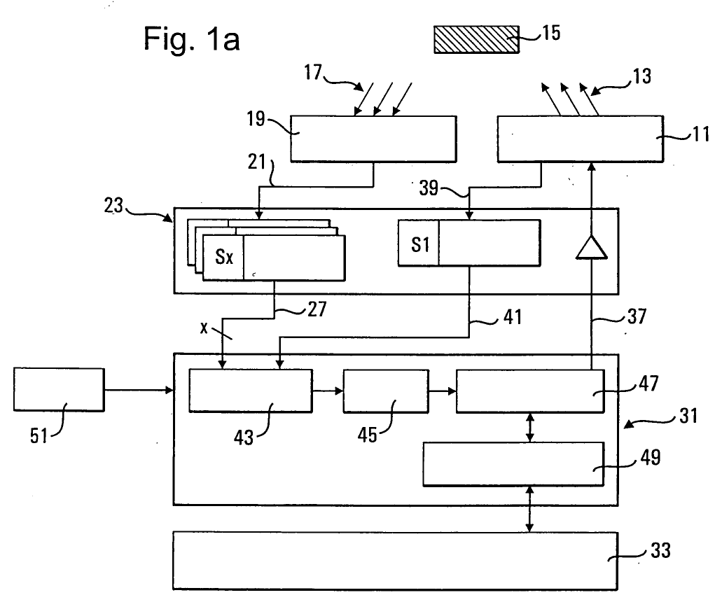

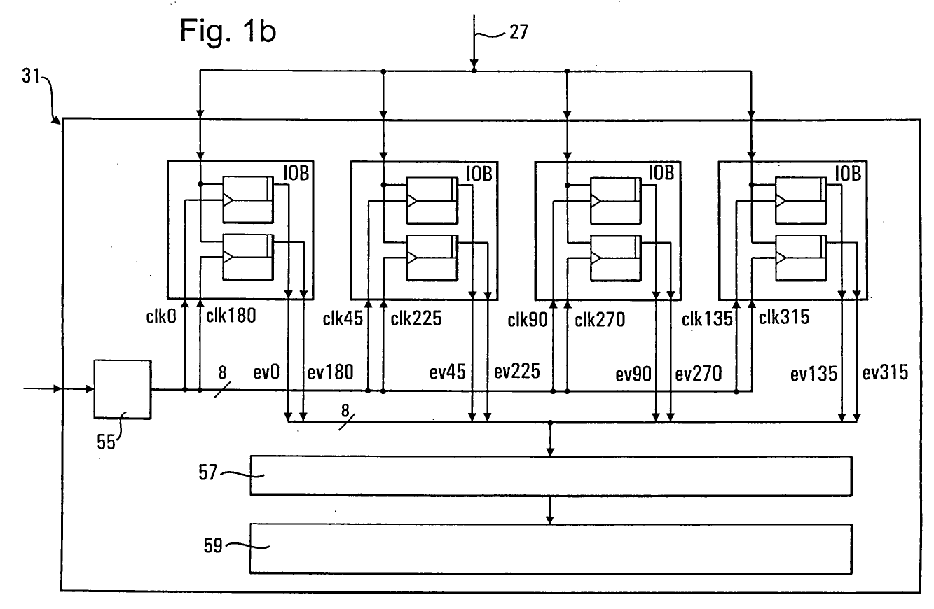

FIG. 1a shows a distance measurement system in accordance with the invention which is designed for one receiver channel. A multi-channel version is generally also possible in which the reflected signal pulses are simultaneously detected by means of a plurality of receivers and the received analog signals are processed in parallel in the manner in accordance with the invention.

A radiation pulse 13 transmitted as the result of a trigger signal 37 from a transmitter 11 including, for example, a laser diode is detected by a receiver 19 including, for example, a diode of the APD type after reflection at one or more objects 15 in the form of one or more reflected signal pulses 17. The receiver 19 generates the received analog signal 21 also termed a backscatter curve in the form of an electric voltage which has a specific time curve and which reflects the time curve of the intensity of the incident radiation 17 “seen” by the receiver 19.

The received analog signal 21 is supplied to a threshold circuit 23 which, in the embodiment shown here, includes a plurality of comparators with threshold values Sx set at different levels. Every comparator Sx generates a respective received logic signal 27 from the received analog signal 21, said received logic signal having a number of logic signal pulses dependent on the received analog signal 21 and on the respective threshold Sx.

The received logic signals 27 are supplied, together with a start pulse signal 41, to the measurement block 43 of an FPGA 31 positioned downstream of the threshold circuit 23. A start pulse 39 generated simultaneously with the transmitted radiation pulse 13 by the transmitter 11 is directed over a further comparator S for the generation of the start pulse signal 41. The logic start pulse 41 serves as a reference point in time in the FPGA 31 for the time measurement on the received logic signals 27 explained in more detail in the following.

In the measurement block 43 of the FPGA 31, the incoming received logic signals 27 are subjected to a sampling process with the help of a clock generator 51 with respect to the starting point in time defined by the logic start pulse 41 and are each mapped on a logic time pattern. An MGT which is integrated in the FPGA 31, which is utilized here as a fast serial-parallel converter and is clocked by the clock generator 51 serves as the high-speed interface to read in the received logic signals 27.

As already mentioned above, the effective sampling rate, and thus the precision of the time measurement, can be increased by specific measures, starting from a given base clock—either of an MGT or also of an FPGA without MGT which is substantially more price favorable in comparison thereto.

A possibility of, for example, increasing eight-fold a base clock of e.g. 320 MHz of a conventional FPGA 31 without MGT and thus of achieving an effective sampling rate of 2.56 GHz, consists in accordance with the invention of utilizing IOBs (input-output blocks) of the FPGA 31 designed in DDR technology (DDR=double data rate) by technical programming measures such that the basic clock is phase-shifted a plurality of times and the input logic signal 27 is thus sampled a plurality of times by means of phase-shifted clocks. FIG. 1b shows a basic design for this purpose. The FPGA 31 includes, in addition to the IOBs, a clock unit 55, a synchronization unit 57 and a processing unit 59.

An alternative or additional measure to increase the precision consists of directly delaying the received logic signals 27 and of sampling the same received logic signal 27 a plurality of times phase-shifted with the base clock—or with a higher clock rate generated by phase shift of the base clock. A delay measure of this kind can be achieved simply, for example by means of hardware, in that the received logic signal 27 is additionally directed over one or more signal lines whose lengths and thus delay times are directly pre-determined.

At the end of the measurement, a time sequence of instantaneous logic values of the received logic signal 27 are present in the FPGA 31 for each comparator Sx in accordance with the time pattern, with the respective instantaneous values of the received logic signal 27 being stored in the corresponding logic units or logic cells of the FPGA 31 for each time interval or time window of the basic clock of the clock generator 51 or of a higher effective cycle with which the received logic signal 27 was sampled.

Each received logic signal 27 is converted into a sequence of zeros and ones, with one zero or one meaning that the received analog signal 21 lies below or above the respective threshold Sx in the respective time window. The width of the time windows, i.e. the fineness of the time pattern and thus the resolution of the time measurement, is determined by the effective clock with which the received logic signal 27 is sampled. As already initially mentioned, FPGAs 31 usable in accordance with the invention are available in the form of standard modules with sampling rates of a plurality of GHz, with which spatial resolutions of a few centimeters can be achieved in the distance measurement. Even more cost-favorable FPGAs, which can be operated at much lower base cycles of e.g. less than 1 GHz, can be used in accordance with the invention by the aforementioned measures to increase the effective sampling rate in order likewise to achieve high measurement precisions.

The received logic signals 27 respectively mapped on a time pattern are supplied to a control block 47 also serving to generate the trigger signal 37 after the measurement has taken place in the measuring block 43 via a data line 54 working according to the FIFO (first-in, first out) principle and are supplied from there to an interface 49 of the FPGA 31 from which the measurement results are transmitted to a downstream external evaluation unit 33.

A possibility of further increasing the measured precision which is preferred in accordance with the invention consists of measuring the start pulse signal 41 in each case together with the received logic signals 27. For this purpose, the start pulse signal 41 and the respective received logic signal 27 are merged before the sampling so that the analog start pulse 39 is treated like a signal pulse 17, i.e. is measured with the same high resolution. The start and the end of the respective time measurement are thereby known with the same high precision.

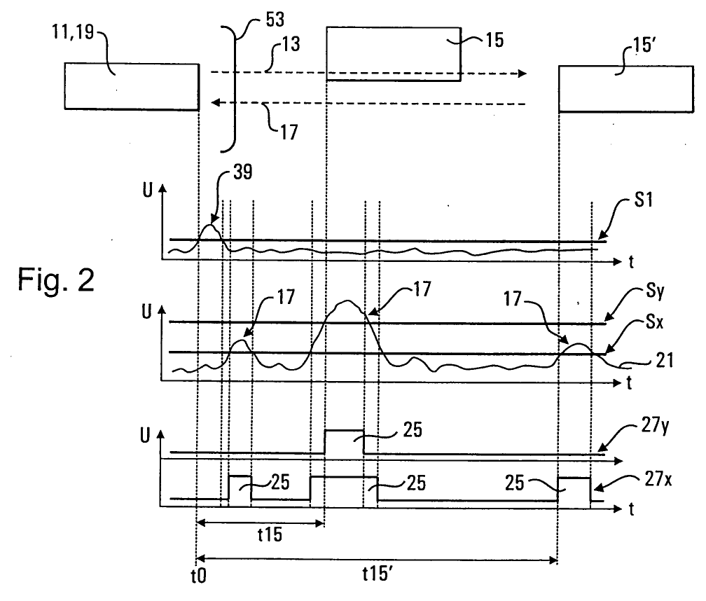

FIG. 2 shows by way of example an application for which the use of a plurality of different thresholds S is sensible. In the example shown, two measurement thresholds Sx, Sy are used.

A lower threshold Sx is set so low that signal pulses 17 which are reflected from objects 15′ relatively far away and which have a relatively low intensity, can still be reliably detected.

The higher threshold Sy serves to suppress unwanted reflections in the near region of the sensor 11, 19 such as are caused, for example, by a cover 53 of the sensor 11, 19. Reflected signal pulses 17, which originate from relatively close objects 15, are likewise detected by means of the high threshold Sy since—with the same reflectance—signal pulses 17 originating from close targets 15 have a higher intensity than signal pulses which are reflected by distant targets 15′.

In the example shown in FIG. 2, two different received logic signals 27x, 27y are consequently generated by means of the two differently set thresholds, Sx, Sy from one single received analog signal 21. A single measurement, i.e. a single backscatter curve 21, thus generally delivers two measurement results.

The received logic signal 27x generated by means of the low threshold Sx includes three logic signal pulses 25 which correspond to the actually reflected signal pulses 17. The received logic signal 27y generated by means of the high threshold Sy, in contrast, only has a logic pulse corresponding to the high signal pulse 17 originating from the close object 15.

In accordance with the invention, both received logic signals 27x, 27y can each be completely subjected to a sampling process, i.e. over the measurement time corresponding to the range of the sensor 11, 19, by means of the FPGA 31 (FIG. 1a) and can be mapped onto a time pattern of the FPGA 31.

Alternatively, it is possible to form only one single measurement result in the FPGA 31 from the two received logic signals 27x, 27y in that, first, the received logic signal 27y generated by means of the high threshold Sy is sampled, in that a switch is made, after a specific period of time during the measurement, to the received logic signal 27x generated by means of the low threshold Sx and this received logic signal 27x is sampled for the remaining measurement time.

The switching point in time can, for example, lie after the detection of the signal pulse 17 originating from the close target 15 by the low threshold Sx so that the measurement result stored in the time pattern of the FPGA 31 only includes the single signal pulse 17 from the near target 16 exceeding the high threshold Sy and the signal pulse 17 from the distant target 15′ only exceeding the low threshold Sx.

The signal pulse 17 originating from the sensor cover 53 and the wide signal pulse 17 from the near target 15 generated by means of the low threshold Sx are thus indeed detected, but are not included in the actual measurement result, i.e. in the sequence of instantaneous logic values stored in the time pattern of the FPGA 31, that is are effectively masked.

The distances from the sensor 11, 19 of the near object 15, on the one hand, and of the distant object 15′, on the other hand, are each determined with respect to the rising flank of the start pulse 39 in that those points in time are determined in the received logic signal 27 mapped onto the time pattern in the FPGA 31 in which a change of the instantaneous logic value takes place from “0” to “1”, since a change of this kind means a rising flank of a logic pulse 25.

The time elapsed since the detection of the rising flank of the start pulse 39, i.e. since the start of the measurement, that is the sought pulse transit time, can be determined simply by counting off the time windows of the time pattern defined precisely in a time respect by the clock generator 51 (FIG. 1a) which have “passed” up to the occurrence of the rising flanks of the logic signal pulses 25. This takes place in the evaluation unit 33 downstream of the FPGA 31 (FIG. 1a). With respect to the starting point in time t0 of the start pulse 39 corresponding to a spacing of zero, the pulse transit times t15 for the near target 15 and t15′ for the distant target 15′ can therefore be measured with a precision corresponding to the fineness of the time pattern and can be converted into the corresponding spacing values via the speed of light.

The finer the time pattern, i.e. the higher the effective clock, is selected, the more precisely the time measurement, and thus the distance measurement, can be carried out in accordance with the invention, with practically no limits being set with respect to the achievable speed and thus spatial resolution to the distance measurement in accordance with the invention due to the flexibility and the speed of modern FPGAs. A high measurement precision and the capability of being able to measure a plurality of events and thus of being able to resolve separate objects or object structures are therefore combined with one another in an extremely advantageous manner in accordance with the invention.

The switching mentioned above between the individual received logic signals 27x can take place, for example, in that a multiplexer function is implemented, while utilizing the programmability of the FPGA 31, which can generally be configured as desired by corresponding programming. On the basis of the respectively physically present thresholds S in a specific sensor, any desired effective time threshold curve can be provided, and also changed, by the programmable multiplexer function in the sense of a jumping to and fro in time between the individual thresholds S.

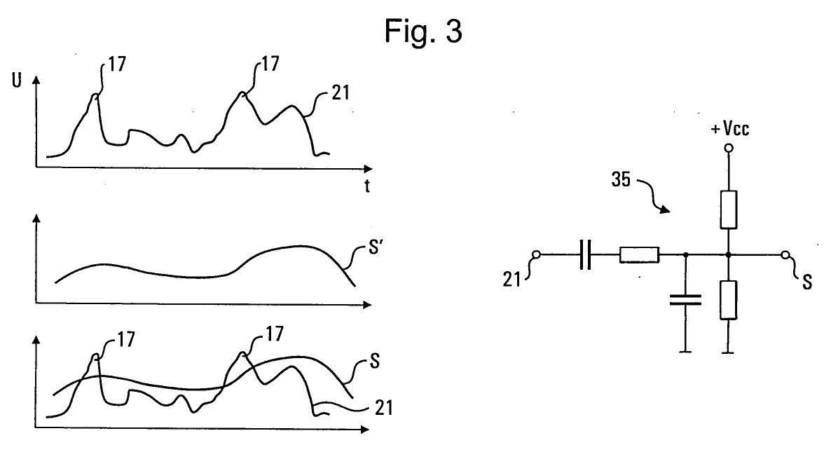

FIG. 3 schematically shows the concept in accordance with the invention of an adaptive threshold. This concept can be used, for example, in vehicle applications in order also to be able to reliably recognize e.g. other preceding vehicles during journeys in fog.

A backscatter curve 21 is shown at the top left in FIG. 3 such as is supplied to the threshold circuit 33 by a receiver 19 on measurements in fog (FIG. 1a). This received analog signal 21 is characterized by a high background on which the signal pulses 17 originating from objects of interest are superimposed. The fog is “seen” by the sensor 11, 19 as an object with an extremely high blur which, however,—unlike noise—does not cause any background of an approximately constant level averaged over time and could therefore not simply be “masked” by a threshold constant in time and set correspondingly high.

In order nevertheless to be able to reliably identify signal pulses 17 originating from objects of interest, in accordance with the invention, the received analog signal 21 is directed over a low-pass filter 35 such as is shown by way of example on the right in FIG. 3, whereby a low-pass filtered, smoothed backscatter curve S′ results. This principle can be used in a varied manner.

Since the low-pass filtered backscatter curve S′ follows the received analog signal 21, the low-pass filtered backscatter curve S′ can serve as a threshold S for the received analog signal 21 still during the measurement, with the low-pass filtered backscatter curve S′ optionally being provided with an offset. In accordance with the representation at the bottom left in FIG. 3, the received analog signal 21 is compared with its own smoothing during the measurement. The signal pulses 17, which are fast in comparison with the background formed e.g. by fog, thus always project out of the filter signal S. This procedure can be termed an auto-adaptive threshold concept since the threshold S′ or S automatically adapts on its own to the actual instantaneous visual conditions.

Alternatively, the smoothed backscatter curve S′ can be averaged over a period in time which is long in comparison with a single measurement, which is in particular possible when the conditions independent of the occurrence of objects of interest change substantially more slowly than the object scenarios. The manner of the averaging is admittedly pre-determined in this process. Nevertheless, the resulting threshold S′ or S adapts to the actual conditions such that the concept of an adaptive threshold can also be spoken of here.

The concept of an adaptive threshold can also be based on the actual measurement results gained with reference to the evaluation of the received logic signals. The respective threshold is—if required—only changed in dependence on the actual measurements.

If more than one threshold is used in the respective application, one or more auto-adaptive or adaptive thresholds of this kind can generally be combined with one or more thresholds of constant levels in time. Principally, in accordance with the invention, all threshold concepts can be used both alone and in combination.

Irrespective of whether an adaptive threshold is worked with or not, the concept in accordance with the invention of a plurality of differently adjusted thresholds in conjunction with the use in accordance with the invention of a measurement device which includes a clocked data reading device and a programmable logic circuit, is of particular advantage since the different received logic signals of the different thresholds can be used fast and simply in any desired manner without any complex analog technology.

Some possibilities to increase the effective sampling rate have already been mentioned above. Further developments of the invention in connection therewith will be explained in the following. These are
a possibility of phase shifting or delaying the received logic signal 27 by utilizing a specific function which is available in more modern FPGA modules (“delay of the received signal”);
a possibility which can be realized in a technical programming manner for the synchronization of a plurality of sampling values obtained with the aid of phase-shifted base clocks to a base clock with the phase shift 0, with the sampling values to be synchronized being obtained by sampling at least one received logic signal 27 by means of the plurality of clocks (base clock+phase-shifted clocks) (“synchronization); and
a possibility of slowing down the further processing of data with respect to the base clock within an FPGA by technical programming measures (“reduction of the processing speed”).

These further developments generally represent independent aspects of the invention, but can also be combined with one other.

Delay of the Received Signal:

The possibility has already been mentioned above of achieving a phase shift of the received logic signal 27 by delay by means of hardware in that the received signal 27 is directed over one or more additional signal lines whose lengths, and thus delay times, are known. Delay lines of this kind can admittedly be easily controlled. There is, however, a requirement that the hardware used, including the programmable logic circuit, permit the implementation of delay lines of this kind at all with respect to their geometry and connections.

Delay lines can generally also be formed by the inner structure of the programmable logic unit, for example from the internal gates or from the carry chain of an FPGA. These internal solutions, however, have the disadvantage that the transit times of the internal components are temperature dependent and moreover vary from module to module. A stable implementation of the delay principle is therefore extremely difficult, if not impossible, in view of the desired measurement precision.

It has surprisingly been found that a feature of more modern FPGA modules is ideally suitable for providing a programmable delay line for the phase shift of a received logic signal 27 which has a guaranteed length which is regulated during operation. This feature is actually a correction feature which is used to correct the timing of the input signals with respect to the FPGA base clock, in particular to avoid time errors (“skew”) between data signals and cycle signals. Such a correction function is also available with a number of previously available FPGAs, but is there only able to be switched on or off, on the one hand, and is subject to the aforesaid fluctuations with respect to the precision, on the other hand.

With the new generation of FPGAs, a delay line can be realized by corresponding programming of the correction function and can be divided into a plurality of delay sections. With the module “Virtex 4” of the company Xilinx, for example, a delay line with a maximum length of 5 ns can be divided into 64 sections, whereby the delays can be varied in steps of approximately 78 ps.

Synchronization:

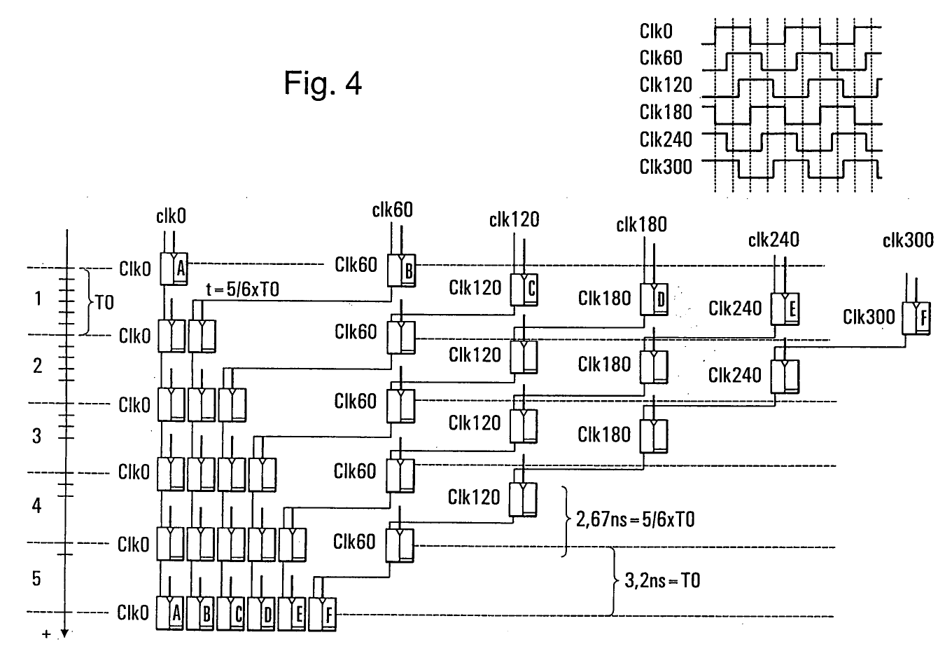

In accordance with FIG. 4, the FPGA base clock Clk0, which amounts e.g. to 312.5 MHz, and thus has a period T0 of 3.2 ns, is phase shifted fivefold by 60° respectively or approximately 0.53 ns. On the sampling of a received logic signal 27, a sampled value (instantaneous value) is consequently obtained every 0.53 ns and is stored in an FGPA register (logic unit). Six sampled values are therefore obtained within one clock period of 3.2 ns; however, not simultaneously, but in a time interval of 0.53 ns in each case. Each of these six sampled values is associated with one of the clocks, namely the base clock Clk0 or one of the phase-shifted clocks Clk60, Clkl20, Clkl80, Clk240 or Clk300.

For the further processing of the measured data (sampled values), it is desirable to synchronize in time the six sampled values obtained at time intervals within a period (T0 of e.g. 3.2 ns) in order to be able to process them jointly as a so-called bit vector. It is therefore necessary to synchronize sampled values obtained at time intervals to a specific clock, in particular to the base clock Clk0.

The short time period available for the takeover of the sampled values from the respective registers into registers provided for the formation of the desired bit vector required for the synchronization is a problem with fast FPGAs, that is with FPGAs with a high base clock, such as are preferably used in accordance with the invention. In the example above, with a takeover taking place with the base clock Clk0, the available takeover time for the sampled values of the clock Clk60 would still amount to 5×T0/6=2.66 ns, whereas the takeover time for the clock Clk300 would only amount to 1×T0/6=0.53 ns. Depending on the design of the FPGA, a limit caused by the hardware is reached which makes a synchronization to the base clock impossible.

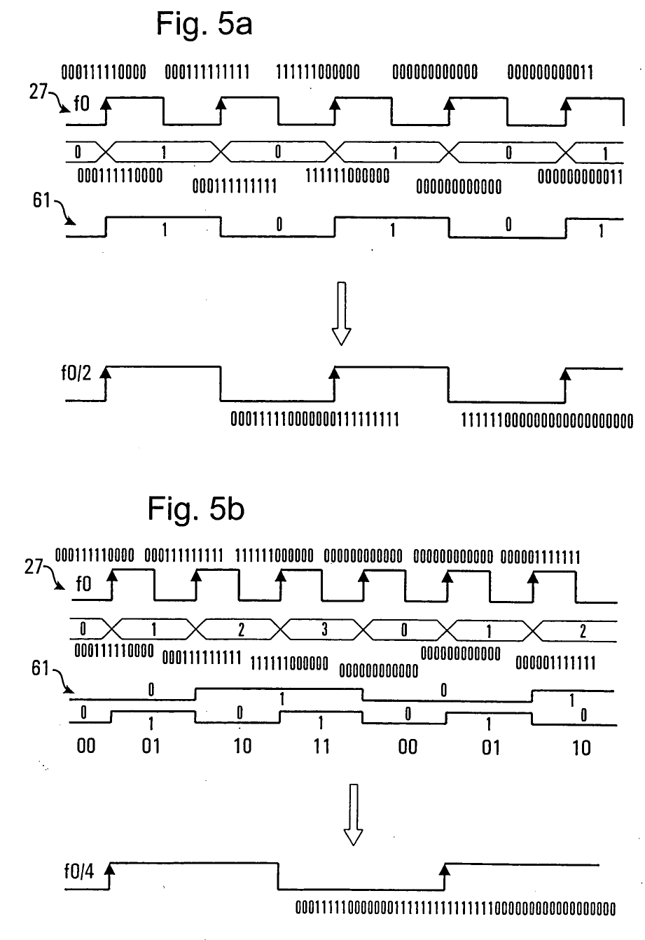

This problem can be solved by a skilled programming of the FPGA, which is in particular illustrated by the lines connecting adjacent columns in FIG. 5. The special procedure consists of the fact that no uniform takeover takes place for the scanned values of the individual clocks, but an individual takeover which takes the respective time position into account.

In the embodiment shown, every scanned value belonging to a specific clock—with the exception of the base clock—and measured within a specific base clock period is taken over during the next base clock period with the clock earlier by one phase. The Clk240 value “E”, for example, is not taken over with the next Clk0 flank (only a time period of 2×T0/6=1.06 ns) would remain up to this), but with the Clk180 flank in the next period or in synchronization stage 2 so that the takeover time amounts to 5×T0/6=2.66 ns.

This takeover rule has the consequence that scanned values A, B, C, D, E and F obtained at time intervals during a period “lie next to one another” in time, i.e. are synchronized, after five periods or synchronization stages and can be further processed together as a six-digit bit vector with the base clock. The takeover time available with this principle is only comparatively slightly reduced with respect to the period T0 of the base clock. With an n-fold phase shift of the base clock, the takeover time amounts to (n−1)/n×T0. It is generally also possible to provide in each case for the takeover not the clock only earlier by one phase, but a still earlier clock and, generally, the takeover can also take place in a later period instead of the period following directly after the measurement period.

Reduction of the Base Clock:

For the further processing of e.g. data obtained by the synchronization explained above, for example in the form of the mentioned bit vectors, the base clock Clk0 of the FGPA used, i.e. so-to-say its instantaneous operating frequency f0, which amounts, for example to 312.5 MHz, may be too high (cf. FIGS. 5a and 5b), said base clock in particular being selected or set in accordance with the desired resolution.

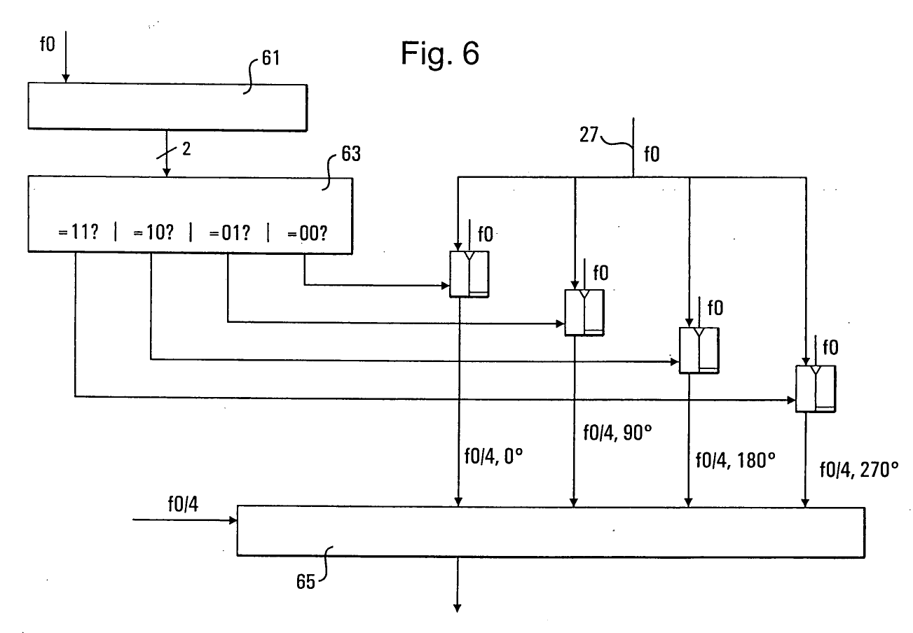

To provide a remedy here, it is proposed in accordance with the invention first to divide the bit vectors of the received logic signal 27 forming the input signal, said bit vectors arriving with the base clock Clk0 and therefore changing with f0, into 2\hat{ }m data streams (e.g. in FIG. 5a into two data streams (m=1) and in FIG. 5b into four (m=2) data streams) which therefore only change with f0/(2 \hat{ }m). For this purpose, the input data stream is in particular (cf. FIG. 6 for the example m=2) divided by means of an arrangement of an m-Bit counter 61 ultimately acting as a frequency divider and a comparator block 63 controlling the respective register with corresponding clock-enable signals, whereby 2 \hat{ }m data streams, i.e. streams of bit vectors, phase-shifted by 360° (2 \hat{ }m) with respect to one another, are generated.

These 2 \hat{ }m data streams are subsequently again synchronized to the rising flank of one of the clocks only changing with f0/(2 \hat{ }Am), whereby a single stream of bit vectors changing with f0/(2 \hat{ }m) result such that the further processing can take place with f0/(2 \hat{ }m).

The processing of the data in the FPGA is hereby slowed by a factor 2 \hat{ }m and as a result—when considered with respect to the register or logic unit of the FPGA—becomes “wider” by just this factor.

The comparisons required in connection with the counters 61 can in particular be carried out for m=1 and m=2 in a look-up table (LUT) of the FPGA, whereby the time effort required for this is minimized.

The general principle of a frequency division, in figurative terms the distribution of a relatively fast input data stream over a plurality of relatively slow part data streams, consequently underlies this reduction in the processing speed, whereby a unit (e.g. counter 61) is in particular used with values which change cyclically in the clock of the input data stream and which can be polled (e.g. by means of the comparator block 63) in order hereby to be able to control the distribution or splitting of the data over the part streams in an ordered manner.

### REFERENCE NUMERAL LIST

11 transmitter
13 transmitted radiation
15, 15′ object
17 reflected signal pulse
19 receiver
21 received analog signal, backscatter curve
23 conversion device, threshold circuit
25 logic signal pulse
27 received logic signal
31 logic circuit, FPGA
33 evaluation unit
35 filter
37 trigger signal
39 start pulse
41 start pulse signal
43 measurement block
45 data line
47 control block
49 interface
51 clock generator
53 cover
55 clock unit
57 synchronization unit
59 processing unit
61 counter
63 comparator block
65 synchronization block
S threshold

The description of the invention is merely exemplary in nature and, thus, variations that do not depart from the gist of the invention are intended to be within the scope of the invention. Such variations are not to be regarded as a departure from the spirit and scope of the invention.

1. A method for distance measurement by determining the pulse transit time, in which pulsed electromagnetic radiation (13) is transmitted using at least one transmitter (11) and signal pulses (17) reflected at objects (15) are detected using at least one receiver (19), wherein at least one received logic signal (27) containing logic signals (25) is generated from the received analog signal (21) containing the signal pulses (17), in particular by means of a threshold circuit (23), and is evaluated with respect to the transit times of the logic signals (25),
characterized in that
the received logic signal (27) is read into a programmable logic circuit (31) by means of a clocked data reading device and is mapped onto a time pattern in the logic circuit (31), in that instantaneous values of the received logic signal (27) are, stored in logic units of the logic circuit (31) associated with the time windows for windows of the time pattern corresponding to at least one clock pulse of the data reading device.

2. A method in accordance with claim 1, characterized in that a plurality of clocks are generated by phase shifting of a base clock.

3. A method in accordance with claim 1, characterized in that the received logic signal (27) is phase shifted.

4. A method in accordance with claim 1, characterized in that at least one FPGA (field programmable gate array) is used as the logic circuit (31).

5. A method in accordance with claim 1, characterized in that at least one serial-parallel converter is used as the data reading device.

6. A method in accordance with claim 1, characterized in that at least one MGT (multi-gigabit transceiver) is used as the data reading unit.

7. A method in accordance with claim 1, characterized in that the instantaneous values are stored in the logic units until the received logic signal (27) has been completely read in.

8. A method in accordance with claim 1, characterized in that the set of the instantaneous values of a received logic signal (27) is supplied to an evaluation unit (33) downstream of the logic circuit (31) as the measurement result.

9. A method in accordance with claim 1, characterized in that a plurality of received logic signals (27) are generated from the received analog signal (21) in that the received analog signal (21) is directed simultaneously or successively via a plurality of thresholds (S) of a threshold circuit (23).

10. A method in accordance with claim 1, characterized in that an adaptive threshold (S) is used whose level changes in time in dependence on the received analog signal (21).

11. A method in accordance with claim 10, characterized in that the adaptive threshold (S) is generated by filtering of the received analog signal (21), in particular by low-pass filtering.

12. A method in accordance with claim 1, characterized in that a measurement result is formed from a plurality of received logic signals (27) supplied to the logic circuit (31).

13. A method in accordance with claim 1, characterized in that switching takes place between the individual received logic signals (27) during the measurement.

14. A method in accordance with claim 1, characterized in that a plurality of received logic signals (27) are simultaneously mapped on time patterns in the logic circuit (31).

15. A method in accordance with claim 1, characterized in that instantaneous values which are obtained during a period (T0) of a base clock (Clk0), which are obtained sequentially in time with the base clock (Clk0) and a plurality of secondary clocks (Clk60, Clk120, Clk180, Clk240, Clk300), which are in particular generated from the bas clock (Clk0) by phase shift, are synchronized to a clock, in particular to the base clock (Clk0), in that each instantaneous value belonging to a specific secondary clock (Clk60, Clk120, Clk180, Clk240 or Clk300) and obtained within a specific base clock period is taken over with an earlier clock during a later base clock period.

16. A method in accordance with claim 1, characterized in that the speed of the further processing of instantaneous values obtained with a base clock (Clk0) of the frequency f0 is reduced by a factor of 2 \hat{ }m in the logic circuit (31) in that first the stream of instantaneous values changing with f0 is divided, in particular by means of an m-Bit counter (61), into 2 \hat{ }m part streams changing with f0/2 \hat{ }m) and shifted in phase by 360°/(2 \hat{ }m) with respect to one another and in that the part streams are subsequently synchronized to a clock of the frequency f0/(2 \hat{ }m).

17. A method in accordance with claim 16, characterized in that the synchronization takes place in accordance with the synchronization principle recited in claim 15.

18. A method in accordance with claim 1, characterized in that the received logic signal (27) is phase-shifted by means of a programmable delay line of the logic circuit (31).

19. Use of a programmable correction function of a logic circuit (31), in particular of an FPGA, which is provided for the time correction of input signals with respect to a base clock,
for the generation of a plurality of signals from a received logic signal (27) which are phase-shifted with respect to one another.

20. Use in accordance with claim 19 of said programmable correction function in a method for distance measurement by determining the pulse transit time, in which pulsed electromagnetic radiation (13) is transmitted using at least one transmitter (11) and signal pulses (17) reflected at objects (15) are detected using at least one receiver (19), wherein at least one received logic signal (27) containing logic signals (25) is generated from the received analog signal (21) containing the signal pulses (17), in particular by means of a threshold circuit (23), and is evaluated with respect to the transit times of the logic signals (25),
characterized in that
the received logic signal (27) is read into a programmable logic circuit (31) by means of a clocked data reading device and is mapped onto a time pattern in the logic circuit (31), in that instantaneous values of the received logic signal (27) are stored in logic units of the logic circuit (31) associated with the time windows for windows of the time pattern corresponding to at least one clock pulse of the data reading device.

21. An apparatus for distance measurement by determining the pulse transit time comprising at least one transmitter (11) for the transmission of pulsed electromagnetic radiation (13) and at least one receiver (19) for the detection of signal pulses (17) reflected at objects (15), wherein a conversion device (23), in particular a threshold circuit, is positioned downstream of the receiver (19) with which at least one received logic signal (27) containing logic signals (25) can be generated from the received analog signal (21) containing the signal pulses (17),
characterized in that
a measurement device having a clocked data reading device and a programmable logic circuit (31) is positioned downstream of the conversion device (23), with the received logic signal (27) read in by means of the data reading device being able to be mapped onto a plurality of logic units of the logic circuit (31), and wherein instantaneous values of the received logic signal (27) can be stored in the logic units of the logic circuit (31) associated with the time windows for times windows of the time pattern corresponding to at least one clock pulse of the data reading device.

22. An apparatus in accordance with claim 21, characterized in that the logic circuit (31) includes at least one FPGA (field programmable gate array).

23. An apparatus in accordance with claim 21, characterized in that the data reading device includes at least one serial-parallel converter.

24. An apparatus in accordance with claim 21, characterized in that the data reading device includes at least one MGT (multi-gigabit transceiver).

25. An apparatus in accordance with claim 21, characterized in that a threshold circuit (23) is adapted to generate an adaptive threshold (S) whose level changes in time in dependence on the received analog signal (21).

26. An apparatus in accordance with claim 25, characterized in that the threshold circuit (23) for the generation of the adaptive threshold (S) includes a filter (35), in particular a low-pass filter, for the received analog signal (21).
